(19) United States
(12) Patent Application Publication
(10) Pub. No.: US 2009/0172761 A1
(43) Pub. Date: Jul. 2, 2009

(54) Method and Apparatus to Facilitate the Local Recording of Audio-Visual Content, in the Absence of End User Requests, for Subsequent Re-Broadcasting

(75) Inventors: Brett Lindsley, Wheaton, IL (US); Matt Defano, Chicago, IL (US); Jianjun Fang, Long Grove, IL (US); Bhavan Gandhi, Vernon Hills, IL (US); Alfonso Martinez Smith, Algonquin, IL (US); Robert G. Scheffler, Peyton, CO (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/965,051

(22) Filed: Dec. 27, 2007

(51) Int. Cl. H04N 7/173

(52) U.S. Cl. 725/114

(57) ABSTRACT

An audio-visual content service provider processor (201) receives (101) audio-visual content (302) from at least a first content provider (203), which audio-visual content is to be distributed to end users (205) of the audio-visual content service provider processor. That audio-visual content service provider processor then facilitates distribution (102) of the audio-visual content to the end users (pursuant, for example, to a corresponding broadcast schedule (304)). This audio-visual content service provider processor also, however, locally records (104) the audio-visual content, in the absence of any corresponding specific requests from the end users, to thereby hold a recorded version of the audio-visual content for subsequent re-broadcasting to the end users.

### RELATED APPLICATION(S)

This application is related to co-pending and co-owned attorney's docket number CML06333 (7303/91203), entitled METHOD AND APPARATUS FOR METADATA-BASED CONDITIONED USE OF AUDIO-VISUAL CONTENT and filed on even date herewith, which is incorporated by reference in its entirety herein.

This application is related to co-pending and co-owned attorney's docket number CML06335 (7303/91205), entitled METHOD AND APPARATUS TO FACILITATE PROVIDING ON-DEMAND ACCESS TO INTERNET MEDIA CONTENT WITH OTHER TELEVISED CONTENT and filed on even date herewith, which is incorporated by reference in its entirety herein.

This application is related to co-pending and co-owned attorney's docket number CML06336 (7303/91206), entitled METHOD AND APPARATUS FOR PROVIDING A DYNAMIC PROGRAMMING GUIDE CONTAINING FUTURE TIMES WHEN ON-DEMAND BROADCASTING REQUESTS CAN BE SATISFIED and filed on even date herewith, which is incorporated by reference in its entirety herein.

### TECHNICAL FIELD

This invention relates generally to audio-visual content-based services and more particularly to the provision of audio-visual content to service provider end users.

### BACKGROUND

Audio-visual materials of various kinds are well known in the art as are various ways of conveying such content to an end user to facilitate the consumption of the former by the latter. In many cases, an audio-visual content service provider obtains such audio-visual content from one or more content providers and arranges for the distribution of that content to one or more end users. In the case of televised audio-visual content, such an audio-visual content service provider often comprises, for example, a Community Access Television (CATV) service provider, an Internet Provider Television (IPTV) service provider, a mobile device service provider (such as a cellular telephony service provider), or the like.

In many cases this audio-visual content is distributed to the end user pursuant to a scheduled multipoint broadcast. By this approach, an audience of end users collectively all independently select a particular channel at a particular time on a particular day to receive a given predetermined and scheduled presentation of a given item of audio-visual content. In many cases such presentations are scheduled days, weeks, or even months in advance. Such an approach, of course, offers little viewing flexibility for the end user.

As a result, many end users employ recording platforms (such as video tape recorders and digital video recorders) at their homes to record scheduled transmissions to enable a later, more convenient private viewing of the scheduled presentation. Such an approach, though generally viewed as technically feasible as well as legal, nevertheless fails to address all end user needs. As one example in this regard, the recording equipment itself can be costly to the end user and/or relatively complicated to utilize. As another example in this regard, a given end user may be interested in viewing more simultaneously presented items of audio-visual content than can be accommodated by their recording equipment.

As a partial attempt to meet these inadequacies, some audio-visual content service providers provide so-called video on demand (VOD) services. By this approach, the end user can make a selection from amongst a relatively small and limited number of audio-visual content items (often relatively recent theatrical releases). Upon making such a selection at a time of convenience, the end user is then able to begin receiving the selected item. Though gaining in popularity, such VOD services nevertheless fail in significant regards to meet the needs of end users in this regard.

As noted, such offerings are usually highly limited in number. These limitations are due, in large part, to a need to carefully negotiate the availability of such content with the original content provider. These negotiations typically entail both technical and legal considerations and are quite ill-suited to any application context that might even begin to approximate a real-time or near-real time operational paradigm. As an effective result, VOD offerings remain, for the most part, relegated to particularly noteworthy, relatively aged audio-visual content where the corresponding support activity appears to be worth the effort.

### BRIEF DESCRIPTION OF THE DRAWINGS

The above needs are at least partially met through provision of the method and apparatus to facilitate the local recording of audio-visual content, the absence of end user requests, for subsequent re-broadcasting described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an audio-visual content service provider processor receives audio-visual content from at least a first content provider, which audio-visual content is to be distributed to end users of the audio-visual content service provider processor. That audio-visual content service provider processor then facilitates distribution of the audio-visual content to the end users (pursuant, for example, to a corresponding broadcast schedule). This audio-visual content service provider processor also, however, locally records the audio-visual content, in the absence of any corresponding specific requests from the end users, to thereby hold a recorded version of the audio-visual content for subsequent re-broadcasting to the end users.

By one approach, this process can further comprise receiving lifecycle instructions regarding the audio-visual content. In such a case, these lifecycle instructions can be used by the audio-visual content service provider processor to determine whether to locally record the audio-visual content as described. For example, these lifecycle instructions can comprise conditions provided by the content provider regarding whether, how, and when the audio-visual content can be legitimately and/or legally recorded in this manner.

These conditions can vary somewhat with the corresponding application setting. By one approach, these conditions can comprise, for example, a lifecycle rule that determines when the audio-visual content must be deleted by the audio-visual content service provider processor. As another example, these conditions can comprise a capture rule that indicates when to capture the audio-visual content.

So configured, those skilled in the art will recognize and appreciate that these teachings provide a flexible and highly scalable mechanism for permitting a wide variety of audio-visual content to be recorded by an audio-visual content service provider processor (even in the absence of a specific request from an end user that such an action occur) such that this recorded content can then later be provided to end users via, for example, a corresponding video on demand process of choice. In particular, these teachings provide an efficient and effective way of permitting a content provider to set any of a wide variety of conditions regarding the recording and retainment of their audio-visual content to thereby provide a simple and powerful basis for permitting and ensuring that the audio-visual content service provider processor deals with such properties and materials in both a technologically and legally appropriate manner.

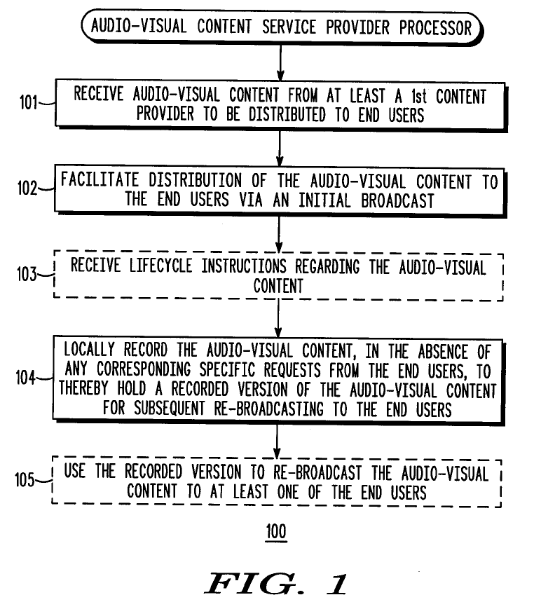

These and other benefits may become clearer upon making a thorough review and study of the following detailed description. Referring now to the drawings, and in particular to FIG. 1, an illustrative process that is compatible with many of these teachings will now be presented.

This process 100 can be carried out at an audio-visual content service provider such as, but not limited to, a Community Access Television (CATV) service provider (which can comprise, for example, a cable-based service provider or a satellite-based service provider), an Internet Protocol Television (IPTV) service provider, a mobile device service provider such as a cellular telephony service provider, and so forth. More particularly, this process 100 can be effectuated at the head end facilities of the audio-visual content service provider as versus, for example, at the facilities of the content providers or at the facilities of the end users.

As described herein, and for the sake of simplicity, this process 100 will be understood to be carried out by a processor. Those skilled in the art will recognize and appreciate that such a processor can comprise a fixed-purpose hard-wired platform or can comprise a partially or wholly programmable platform. It will also be understood that such a “processor” can comprise a single platform or can comprise a logical architecture wherein the described functionality is distributed over two or more supporting platforms. All of these architectural options are well known and understood in the art and require no further description here.

This process 100 provides for this processor receiving 101 audio-visual content from at least a first content provider, wherein this audio-visual content is received with the understanding and intent that the content be distributed to end users of the audio-visual content service provider. Such reception can be facilitated using, for example, a content delivery plane in accordance with well-understood practice in this regard. (As used herein, the expression “plane” will be understood to refer to the data delivery mechanism/technology and hence can comprise, for example, a data packet-based transport channel, a switched circuit-based transport channel, and so forth.)

In many application settings, the audio-visual content service provider processor may also receive broadcast scheduling instructions regarding when the audio-visual content service provider is to broadcast the audio-visual content to the end users. In some cases, the instructions are not required as the content is to be immediately relayed to the end users upon reception. In other cases, however, the audio-visual content service provider stores the received audio-visual content and holds that content for broadcasting to the end users at specified date/time as may be dictated by the sourcing content provider. By one approach, this can comprise broadcasting the audio-visual content to end users via a broadcast schedule service (as versus, for example, a video on demand service).

In any event, this process 100 then provides for facilitating the distribution 102 of the audio-visual content to the end users via an initial broadcast. This can comprise, for example, broadcasting the audio-visual content to the end users at a predetermined time as has been established and/or otherwise agreed to with the content provider. In such a case, individual end users watch (or arrange to record using an end-user tape-based or digital recorder) the broadcast as they wish. As used herein, those skilled in the art will understand that this particular distribution comprises the primary purpose of the content provider having provided the audio-visual content to the audio-visual content service provider.

Those skilled in the art will recognize and understand that the steps described in the foregoing discussion of this process 100 can comprise prior art practice in this regard if desired. In sum and substance, these steps essentially permit one or more content providers to provision an audio-visual content service provider with audio-visual content that the audio-visual content service provider then distributes to its end users en masse via a broadcast schedule. These end users can consult a broadcast schedule to determine when to view the audio-visual content.

This process 100 will also optionally provide for receiving 103 lifecycle instructions which can comprise conditions regarding the audio-visual content. By one approach, these lifecycle instructions can comprise metadata that is received from the same content provider as provided the aforementioned audio-visual content. By one approach, this metadata can be received via a metadata delivery plane. Such a metadata delivery plane can be physically and/or logically discrete from the aforementioned content delivery plane or can be physically and/or logically combined or interleaved therewith as desired. By one approach, this metadata can be received by the audio-visual content service provider at essentially the same time as the audio-visual content service provider receives the corresponding audio-visual content. By another approach, this metadata can be received in advance of, or following the receipt of, the audio-visual content. It would also be possible to parse the metadata into portions that are received at various times. For example, one condition might be received prior to receipt of the audio-visual content while another condition is received contemporaneously with receipt of the audio-visual content.

The lifecycle instructions themselves can vary with respect to the needs, limitations, and/or opportunities as tend to characterize a given application setting. As used herein, these lifecycle instructions will be understood by those skilled in the art to comprise instructions regarding permitted (or prohibited) recording and storage of the audio-visual content other than with respect to one or more original scheduled broadcasts of the audio-visual content to the end users (such as the broadcasting contemplated by the distribution step 102 described above). Examples in this regard might include, but are not limited to, rules regarding whether a particular item of audio-visual content can be recorded at all, and if so, how long that recording can be maintained in storage by the audio-visual content service provider.

This process 100 will accommodate receiving such lifecycle instructions from any authorized entity. This can include, for example, the original content source. This can also include, however, such sources as an agent for the content source, legal counsel for the content source, or even an industry organization that provides such services to subscribing content source members. Those skilled in the art will appreciate that these teachings will also accommodate considerably more complicated legal scenarios. For example, it is possible for a given item of audio-visual content to have ownership and/or control dispersed over a number of controlling entities (such as a production house, acting talent, the director, and the writers). In such a case, these teachings will ready accommodate receiving lifecycle instructions from each of these entities regarding their separate and independent conditions of usage.

Using these lifecycle instructions this process 100 can then provide, for example, for locally recording 104 the audio-visual content to thereby hold a recorded version of that audio-visual content for subsequent re-broadcasting to the end users. As used herein, this “re-broadcasting” will be understood to refer to video on demand and/or individually scheduled re-broadcasts as versus multipoint re-broadcasts to the end user population as a whole. Also as used here, this reference to “locally recording” will be understood to comprise recording by or under the specific control and auspices of the audio-visual content service provider itself and not, for example, the end users. Accordingly, such local recording can occur literally within the physical head end facilities of the audio-visual content service provider or at another physical location that is, nevertheless, under the control of the audio-visual content service provider in this regard.

Those skilled in the art will recognize and appreciate that this step of locally recording the audio-visual content can occur in the absence of any corresponding specific requests from any of the end users. This, of course, holds the potential that an item of audio-visual content will be recorded that will not actually be re-broadcast to an end user, as it is possible that no end user will later request that content. Notwithstanding this possibility, however, the applicant's have determined that this functionality can nevertheless provide, on balance, a considerably richer quantity and quality of viewing opportunities for end users than prior art practice in this regard.

The actual recording can be carried out using any capture and storage technology of choice. For many application settings this can comprise the use of digital video recorders that capture and store the audio-visual content as digital information in a corresponding digital memory. Numerous examples exist in this regard and are well known to those skilled in the art. As these teachings are not particularly sensitive to any particular selections in this regard, for the sake of brevity further elaboration in this regard will not be provided here.

This process 100 can then optionally provide for using 105 the recorded version of the audio-visual content to re-broadcast the audio-visual content to at least one of the end users. This can comprise, for example, video on demand broadcasts as may be requested from time to time by various ones of the end users.

Those skilled in the art will recognize that certain of the activities described with respect to this process 100, though technologically feasible, run contrary to ordinary thinking and practice due to serious and widespread concerns regarding the legal rights and/or preferences of the parties providing the audio-visual content. In particular, recording of the audio-visual content by the audio-visual content service provider, retaining that recorded content in storage, and later distributing that recorded content in an on-demand context are all activities that can lead to catastrophic legal challenges as well as greatly impaired business relations with parties necessary to the ongoing successful operations of the audio-visual content service provider.

By providing and using the aforementioned lifecycle instructions, however, on-the-fly decisions can be made and safely relied upon regarding such actions as recording, retaining, and subsequent re-broadcasting of individual items of audio-visual content. Such a process effectively allows such functionality to be implemented in a largely or fully automated setting and further without requiring time consuming negotiations.

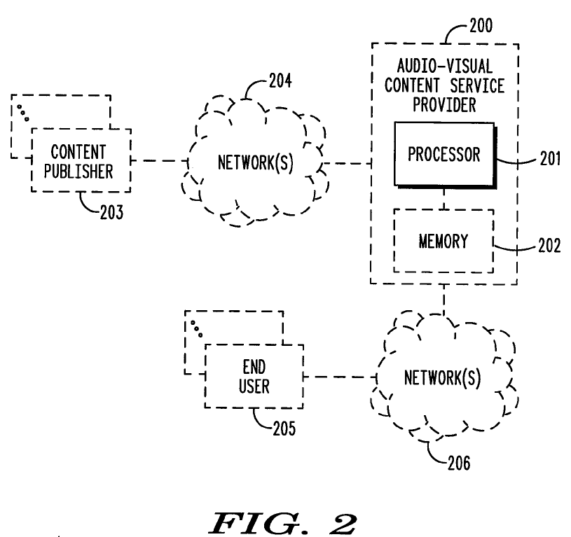

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example, an audio-visual content service provider 200 comprises, in part, a processor 201 that can operably couple to a memory 202 as desired. Such a memory can serve, for example, to store audio-visual content that has been recorded by the audio-visual content service provider pursuant to these teachings. These facilities can operably couple to one or more content publishers 203 via one or more intervening networks 204 (such as the Internet, dedicated landlines, or other wireline/wireless carriers of choice). These content publishers 203 can source the aforementioned audio-visual content and lifecycle instructions and the audio-visual content service provider processor 201 can receive such information via the aforementioned network(s) 204.

The audio-visual content service provider's facilities can further operably couple to one or more end users 205 (such as a plurality of residential facilities such as homes, condominiums, apartments, and so forth) via one or more intervening networks 206. This network(s) 206 may be the same, in whole or in part, as the network(s) 204 that couple the audio-visual content service provider's facilities to the content publisher(s) 203 or may be different as appropriate to the specifics of a given application setting. By one approach, this network 206 can comprise a cable-based or a satellite-based television broadcasting distribution system as are well known in the art.

So configured, the aforementioned processor 201 can be configured and arranged, via, for example, corresponding programming as will be well understood by those skilled in the art, to carry out one or more of the aforementioned steps, actions, and functions. This can comprise, for example, receiving the described audio-visual content from the content publisher 203, facilitating distribution of that audio-visual content to the end users 205, receiving 103 the aforementioned lifecycle instructions that comprises conditions regarding the recording and retention of the audio-visual content, and locally recording 104 such audio-visual content (in the absence of any corresponding specific requests from the end users) to thereby hold a recorded version of the audio-visual content for subsequent re-broadcasting to the end users.

Those skilled in the art will recognize and understand that such a facility 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

To further demonstrate the capabilities and effectiveness of these teachings, a more detailed description of a given illustrative instantiation will now be provided. Those skilled in the art will recognize and understand that the specifics of this example serve an illustrative purpose only and are not offered with any suggestion or intent that these specifics comprise an exhaustive listing of all such possibilities in this regard.

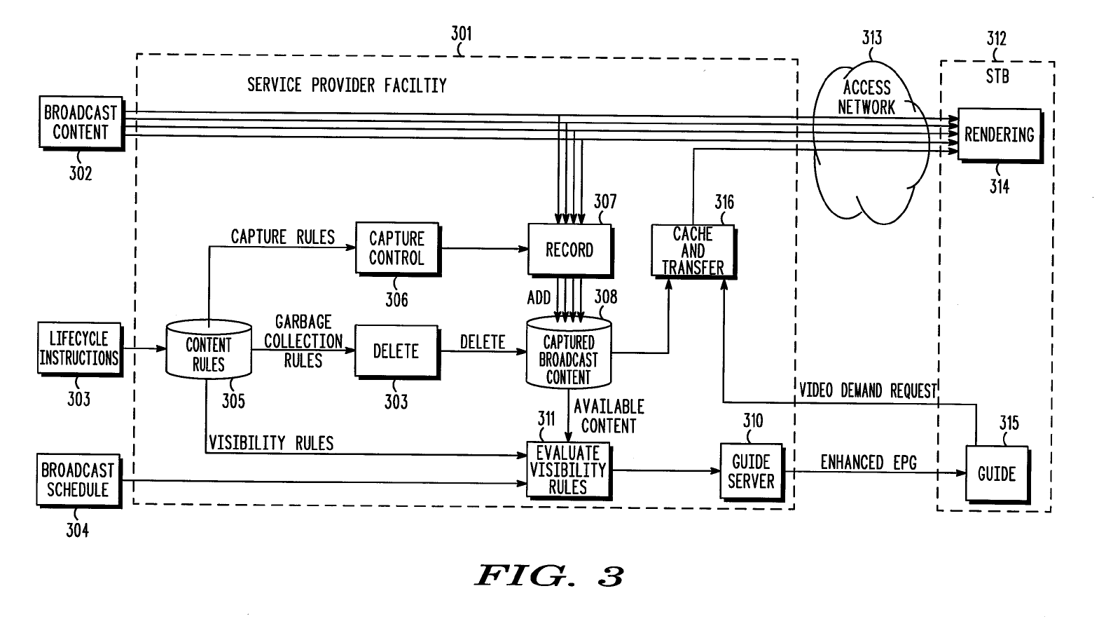

In this example, and referring now to FIG. 3, a service provider facility 301 receives television broadcast content 302, lifecycle instructions 303 as correspond to some or all of the broadcast content 302, and a broadcast schedule 304 as also corresponds to that broadcast content 302 (typically, though not necessarily, as all provided by a corresponding content publisher). The service provider facility 301 includes a content rules store 305 where the received lifecycle instructions are retained for use by various other components at the service provider facility 301.

One such component comprises a capture control 306. The capture control 306 utilizes the lifecycle instructions to determine which items of the broadcast content to record. By one approach, this can comprise recording all broadcast content except that broadcast content which is specifically excepted by the lifecycle instructions. By another approach, this can comprise effecting a bias towards recording no broadcast content except where such recording is expressly permitted as per the lifecycle instructions. The capture control 306 in turn controls a record capability 307. The record capability 307 records broadcast content as per the capture control 306 and provides for the storage of such recorded content in a captured broadcast content store 308.

Another such component comprises a delete capability 309. This delete capability 309 utilizes the lifecycle instructions to determine when to delete various items of recorded content as are retained in the captured broadcast content store 308. By one approach, this can comprise retaining each item of recorded content unless and until a specific delete instruction comprises a part of the lifecycle instructions as pertain to a given item of recorded content. By another approach, this can comprise only retaining each item of recorded item for a given amount of fixed time (such as one week or one month) unless some different duration is specified by corresponding lifecycle instructions. Other approaches in this regard are possible as well.

The illustrated facility 301 also comprises a guide server 310 that provides information regarding scheduled broadcasts of broadcast content to end users. The specific output of the guide server 310, often known as an electronic programming guide (EPG), is well known in the art and requires no further description here. In this example, however, the aforementioned content rules 305 may also comprise so-called visibility rules that pertain to when and how a given item of recorded broadcast content can be subsequently delivered and utilized. To accommodate these additional conditions regarding “visibility” of the broadcast content, an evaluate visibility rules capability 311 processes these additional conditions and provides a corresponding output to the guide server 310 to thereby permit the latter to use such information as appropriate when forming the contents of the resultant guide.

By one approach, and as illustrated, the evaluate visibility rules capability 311 can also utilize information regarding available recorded content in the captured broadcast content store 308 when providing information to the guide server 310. So configured, the guide server 310 can provide an enhanced electronic programming guide by including, along with information regarding scheduled broadcasts of broadcast content, additional information regarding the availability of captured broadcast content via a corresponding video on demand opportunity.

So configured, a given end user (via, in this example, their so-called set top box 312) is able to receive an original broadcast of such broadcast content via an intervening access network 313 of choice (such as a cable distribution network, a satellite-based delivery system, and so forth) and render that broadcast content visible/audible via a corresponding rendering capability 314. Such functionality is well understood in the art.

An end user of the set top box 312, in turn, can access a guide 315 as is provided by the aforementioned guide server 310 to identify viewing opportunities of interest. When the end user selects an item of captured broadcast content, this selection can be entered via the guide 315. Upon receiving this request, the service provider facility 301 can utilize a cache and transfer capability 316 to provide for the streaming of the requested item of recorded audio-visual content to the end user's set top box 312.

Those skilled in the art will recognize and appreciate that these teachings provide a simple yet powerful mechanism by which an entity having a proprietary interest in an item of audio-visual content can comfortably (both technologically and legally) provide that content to a content distributor such as a cable television service provider in a way that permits the latter to make use of that content in a way that is supplemental to an ordinary broadcast of that content and yet as controlled as desired by the former. These teachings are readily scalable and will accommodate handling essentially any volume of content over essentially any practical time frame. These teachings are also highly scalable with respect to offering an ability to accommodate a virtually unlimited number of unique and differentiated content provider-based/sourced conditions regarding such usage.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at an audio-visual content service provider processor:
receiving audio-visual content from at least a first content provider to be distributed to end users of the audio-visual content service provider;
facilitating distribution of the audio-visual content to the end users via an initial broadcast;
locally recording the audio-visual content, in the absence of any corresponding specific requests from the end users, to thereby hold a recorded version of the audio-visual content for subsequent re-broadcasting to the end users.

2. The method of claim 1 wherein the audio-visual content service provider comprises at least one of:
a Community Access Television (CATV) service provider;
an Internet Protocol Television (IPTV) service provider;
a mobile device service provider.

3. The method of claim 1 further comprising:
receiving lifecycle instructions regarding the audio-visual content; and wherein locally recording the audio-visual content comprises using the lifecycle instructions to determine:
whether to locally record the audio-visual content to thereby provide the recorded version.

4. The method of claim 3 wherein locally recording the audio-visual content further comprises using the lifecycle instructions to determine a duration of time to retain the recorded version before deleting the recorded version.

5. The method of claim 1 further comprising:
using the recorded version to re-broadcast the audio-visual content to at least one of the end users.

6. The method of claim 5 wherein using the recorded version to re-broadcast the audio-visual content to at least one of the end users comprises using the recorded version to transmit an on-demand broadcast of the audio-visual content to a specific end user.

7. The method of claim 1 wherein:
receiving audio-visual content comprises receiving, via a plurality of channels, a plurality of different audio-visual content;
locally recording the audio-visual content comprises locally recording the plurality of different audio-visual content, in the absence of any corresponding specific requests from the end users, to thereby hold recorded versions of the plurality of audio-visual content for subsequent re-broadcasting to the end users.

8. An apparatus comprising:
an audio-visual content service provider processor that is arranged and configured to:
receive audio-visual content from at least a first content provider to be distributed to end users of the audio-visual content service provider;
facilitate distribution of the audio-visual content to the end users via an initial broadcast;
locally record the audio-visual content, in the absence of any corresponding specific requests from the end users, to thereby hold a recorded version of the audio-visual content for subsequent re-broadcasting to the end users.

9. The apparatus of claim 8 wherein the audio-visual content service provider comprises at least one of:
a Community Access Television (CATV) service provider;
an Internet Protocol Television (IPTV) service provider;
a mobile device service provider.

10. The apparatus of claim 8 wherein the audio-visual content service provider processor is further configured and arranged to:
receive lifecycle instructions regarding the audio-visual content; and
locally record the audio-visual content by using the lifecycle instructions to determine whether to locally record the audio-visual content to thereby provide the recorded version.

11. The apparatus of claim 10 wherein the audio-visual content service provider processor is further configured and arranged to locally record the audio-visual content by using the lifecycle instructions to determine a duration of time to retain the recorded version before deleting the recorded version.

12. The apparatus of claim 8 the audio-visual content service provider processor is further configured and arranged to use the recorded version to re-broadcast the audio-visual content to at least one of the end users.

13. The apparatus of claim 12 wherein the audio-visual content service provider processor is further configured and arranged to use the recorded version to re-broadcast the audio-visual content to at least one of the end users by using the recorded version to transmit an on-demand broadcast of the audio-visual content to a specific end user.

14. The apparatus of claim 8 wherein the audio-visual content service provider processor is further configured and arranged to:
receive audio-visual content by receiving, via a plurality of channels, a plurality of different audio-visual content;
locally record the audio-visual content by locally recording the plurality of different audio-visual content, in the absence of any corresponding specific requests from the end users, to thereby hold recorded versions of the plurality of audio-visual content for subsequent re-broadcasting to the end users.
